(19) United States
(12) Patent Application Publication
(10) Pub. No.: US 2024/0214739 A1
(43) Pub. Date: Jun. 27, 2024

(54) HIGH EXCURSION, LOW DISTORTION AND LOW DEPTH SPEAKER

(71) Applicant: CABASSE, plouzane (FR)

(72) Inventor: Cyrille DODARD, plouzane (FR)

(21) Appl. No.: 17/756,798

(22) PCT Filed: Dec. 7, 2020
(86) PCT No.: PCT/EP2020/084944

§ 371 Date: Jun. 2, 2022

(30) Foreign Application Priority Data
Jun. 12, 2019 (FR) FR1913873
Mar. 31, 2020 (FR) FR2003175
Mar. 31, 2020 (FR) FR2003184
Mar. 31, 2020 (FR) FR2003187

(51) Int. Cl. H04R 9/02; H04R 9/04; H04R 31/00

(52) U.S. Cl. CPC H04R 9/025; H04R 9/045; H04R 31/00

(57) ABSTRACT

The speaker (60) comprises a magnet (40) associated with at least one polar part (39, 41) for producing a magnetic field in a gap and a moving part comprising: —a first coil carcass (48) supporting a conductive winding (42) in the gap; —a rigid internal membrane (47) and a core cover (45) secured to the first carcass; —a second coil carcass (49) positioned on the outside of the polar parts and mounted on a rear suspension (36); —an external membrane (50) secured to the rigid internal membrane, the second carcass and a front suspension (31); and —two electric conductors (33, 46) connected to the winding and passing through the first coil carcass, an aerial path between the coil carcasses, the second coil carcass and an aerial path to a fixed point (34) of the speaker, the assembly formed by the core cover, the internal membrane and the external membrane having a convex shape, the convexity of which is oriented towards the outside of the speaker, the rigid internal membrane comprising a cylindrical or conical part (27) inside the speaker and secured to the first coil carcass, the external membrane comprising a cylindrical or conical part (56) inside the speaker and secured to the second coil carcass.

### TECHNICAL FIELD OF THE INVENTION

The present invention relates to a high excursion, low distortion and low depth Speaker (“LS”).

It applies, among others, to the field of audio and acoustics, for example the audio channels known as “high-fidelity” or HIFI.

The field of the invention is that of speakers or electrodynamic transducers, and more specifically of speakers dedicated in particular to the reproduction of low frequencies (“large” effective projected area, “heavy” moving part, high excursion, high force factor, high power handling).

### STATE OF THE ART

The known electrodynamic speakers designed to reproduce low frequencies generally have substantial dimensions, because:
a) The “heavy” moving parts required to reproduce low frequencies require a magnetic circuit (motor) that is powerful, and therefore generally of a large size.
b) The significant excursion of the moving part as a consequence of the reproduction of low frequencies results in a significant total height of the speaker.
c) The good translational guide of the moving part for large excursions requires a large distance between the front and rear suspensions of the speaker, which further increases the total height of the speaker. These known speakers present a number of drawbacks.

In particular, their dimensions are large. Today, one seeks to produce cabinets that are compact, in particular not very deep, while ensuring a significant acoustic level in the low frequencies. The dimensions of high-quality conventional speakers dedicated to the reproduction of low frequencies is very often the obstacle preventing the reduction in size of speaker systems.

### DESCRIPTION OF THE INVENTION

The present invention aims to remedy all or part of these drawbacks.

To this end, according to a first aspect, the present invention relates to a speaker which comprises a magnet associated with at least one polar part for producing a magnetic field in a gap and a moving part comprising:
a first coil carcass supporting a conductive winding in the gap;
a rigid internal membrane and a core cover secured to the first carcass;
a second coil carcass positioned on the outside of the polar parts and mounted on a rear suspension;
an external membrane secured to the rigid internal membrane, the second carcass and a front suspension; and
two electric conductors connected to the winding and passing through the first coil carcass, an aerial path between the coil carcasses, the second coil carcass and an aerial path to a fixed point of the speaker,
   the assembly formed by the core cover, the internal membrane and the external membrane having a convex shape, the convexity of which is oriented towards the outside of the speaker, the rigid internal membrane comprising a cylindrical or conical portion inside the speaker and secured to the first coil carcass, the external membrane comprising a cylindrical or conical portion inside the speaker and secured to the second coil carcass.

Thanks to these provisions, one reduces the dimensions, in particular the depth, of the speaker designed in particular to reproduce low frequencies, while preserving the special properties necessary for the high-quality reproduction of low and medium frequencies in the audible spectrum. One can therefore reduce the size, in particular the depth, of the cabinets/acoustic baffles coupled to this speaker and necessary for it to operate properly.

By adding a second coil carcass to the moving part, the rear suspension can be positioned outside and towards the back of the speaker. This makes it possible to maximise the distance between the front and rear suspensions, which ensures a good translational guide of the moving part, without in any way increasing the depth of the speaker.

The present invention makes it possible to produce speakers whose enclosed acoustic load has a volume less than the product of the surface area of all the membranes and its maximum excursion.

In some particular embodiments, in orthogonal projection along the axis of displacement of the moving part, the gap has a length greater than the length of the winding, the front and rear suspensions being configured to maintain the entire winding in the gap up to the maximum excursions of the moving part. This type of design, known as “underhung”, further boosts the compactness of the speaker, especially in combination with the other particular features of the invention.

In some embodiments, the magnet is a central magnet whose orthogonal projection orthogonal along a plane perpendicular to the axis of displacement of the moving part is completely inside said projection of the first coil carcass, two polar parts being mounted on two surfaces of the magnet.

Thanks to this configuration, the magnetic leaks are particularly limited, which boosts the efficiency of the speaker.

In some embodiments, the diameter of the first coil carcass is more than half the outer diameter of the external membrane.

This coil carcass with a relatively large diameter makes it possible to maximise the power handling and the force factor Bl when a central magnet is used, since its diameter can be greater.

In some embodiments, the winding comprises at least four layers.

Thanks to these provisions, the force factor Bl is improved.

In some embodiments, at least one of the coil carcasses comprises air circulation through-openings. These openings encourage the cooling of the winding and reduce the effects of overpressure inside the coil carcasses during the movements of the moving part.

In some embodiments, the external polar part has a chamfer on the side of the second coil carcass.

This chamfer encourages the circulation of air in the through-openings of the second coil carcass.

In some embodiments, the external polar part comprises through-openings parallel to the axis of displacement of the moving part.

These through-openings reduce pressure variations behind the moving part during the displacements of this moving part. These through-openings also boost the power handling of the speaker by creating an air current in the gap, which helps cool the winding.

In some embodiments, the speaker comprises, in the gap, a counter-inductance ring.

The counter-inductance ring inserted inside the gap reduces the inductance of the winding to improve the efficiency of the speaker, especially at the top end of its bandwidth, and to reduce distortions, especially current distortions.

The counter-inductance ring makes it possible to reduce the non-linearity phenomena linked to variations in the inductance of the first coil carcass.

In some embodiments, the counter-inductance ring is positioned on the outer side of the gap.

This position allows the diameter of the magnet to be maximised for a given diameter of the inner coil carcass, which maximises the magnetic energy.

In some embodiments, the counter-inductance ring is made of materials with a magnetic permeability approximately equal to 1.

In some embodiments, the counter-inductance ring is made of copper or aluminium.

In some embodiments, the counter-inductance ring covers the entire height of the gap.

In some embodiments, the counter-inductance ring has a thickness of between 0.5 and two millimetres and, preferably, between 0.5 and 1.5 millimetres.

In some embodiments, the counter-inductance ring is positioned in the gap outside the winding, the magnet being a central magnet whose orthogonal projection along a plane perpendicular to the axis of displacement of the moving part is completely inside said projection of the first coil carcass, the two polar parts being mounted on two surfaces of the magnet.

In some embodiments, the magnet is made of Neodymium-Iron-Boron (NdFeB).

In some embodiments, at least one suspension has a rotationally symmetrical shape whose radial cross-section exhibits oscillations whose extreme amplitudes form at least one cone whose apex is oriented towards the front of the speaker, the suspensions being jointly configured to apply to the moving part a return force that compensates for the non-linearity due to the variation in acoustic stiffness produced by the compression/depression of the internal load volume.

Thanks to each suspension that is asymmetrically shaped, i.e. where the central portion is oriented towards the front of the speaker, one compensates, at least partiality, for the non-linearity of the acoustic stiffness of the closed cabinet coupled to the speaker, significant non-linearity, in the case of a low load volume frequently inherent in the use of a speaker with a small depth.

In some embodiments, the rear suspension has a rotationally symmetrical shape whose radial cross-section exhibits oscillations forming at least two cones whose apex is oriented towards the front of the speaker.

In these embodiments, the asymmetrically-shaped rear suspension takes part in this compensation.

In some embodiments, the amplitude of the oscillations is greater towards the central axis of the rear suspension than towards the perimeter of the rear suspension.

In some embodiments, the amplitude of the oscillations is lower towards the central axis of the rear suspension than towards the perimeter of the rear suspension.

These oscillations with different amplitudes favour the deformation of the suspension during to-and-fro movements of the moving part while ensuring the compensation for stiffness performed by the suspension.

In some embodiments, the oscillations have a constant pitch.

In some embodiments, the oscillations are sinusoidal.

According to a second aspect, which is preferably combined with general or particular characteristics of its first aspect, the present invention relates to a speaker which comprises a moving part comprising:
a first coil carcass supporting a conductive winding with at least four layers in the gap;
a rigid internal membrane and a core cover secured to the first carcass.

The speaker also comprises a magnet associated with at least one polar part for producing a magnetic field in a gap, the counter-inductance ring being positioned in the gap outside the winding, wherein the magnet is a central magnet whose orthogonal projection orthogonal along a plane perpendicular to the axis of displacement of the moving part is completely inside said projection of the first coil carcass, two polar parts being mounted on two surfaces of the magnet, a speaker wherein, in orthogonal projection along the axis of displacement of the moving part, the gap has a length greater than the length of the winding, the front and rear suspensions being configured to maintain the entire winding in the gap up to the maximum excursions of the moving part.

This design of the motor assembly—“underhung” with a central magnet, preferably of NdFeB type, having a coil with at least four winding layers, and a counter-inductance ring positioned outside the winding—gives a motor that is particularly well optimised in terms of performance/compactness.

The counter-inductance ring inserted inside the gap reduces the inductance of the winding to improve the efficiency of the speaker, especially at the top end of its bandwidth, and to reduce distortions, especially current distortions. The counter-inductance ring makes it possible to reduce the non-linearity phenomena linked to variations in the inductance of the first coil carcass.

The design known as “underhung” further boosts the compactness of the speaker, in combination with other particular features of the invention, in particular the configuration with a central magnet, wherein the magnetic leaks are particularly limited.

In some embodiments, the diameter of the first coil carcass is more than half the inner diameter of a front suspension of the speaker.

The coil carcass with a relatively large diameter makes it possible to maximise the power handling and the force factor Bl when a central magnet is used, since the diameter of this magnet can be greater.

In some embodiments, the counter-inductance ring is positioned on the outer side of the gap.

This position allows the diameter of the magnet to be maximised for a given diameter of the inner coil carcass, which maximises the magnetic energy.

According to a third aspect, which is preferably combined with general or particular characteristics of its first and second aspects, the present invention relates to a speaker which comprises a magnet associated with at least one polar part for producing a magnetic field in a gap and a moving part comprising:
a first coil carcass supporting a conductive winding in the gap;
a rigid internal membrane and a core cover secured to the first carcass and connected to a first suspension;
   wherein at least one suspension has a rotationally symmetrical shape whose radial cross-section exhibits oscillations whose extreme amplitudes form at least one cone whose apex is oriented towards the front of the speaker, the suspensions being jointly configured to apply to the moving part a return force that compensates for the non-linearity due to the variation in acoustic stiffness produced by the compression/depression of the internal load volume.

Thanks to each suspension that is asymmetrically shaped, i.e. where the central portion is oriented towards the front of the speaker, one compensates, at least partiality, for the non-linearity of the acoustic stiffness of the closed cabinet coupled to the speaker, significant non-linearity, in the case of a low load volume inherent in a speaker with a small depth.

According to a fourth aspect, the present invention relates to a method of assembling a speaker according to one of the other aspects of the present invention, which method comprises, in order, the following steps:
positioning a passive second coil carcass outside a motor;
soldering wires of the second carcass to a terminal block of the speaker;
gluing a front suspension and an external membrane to the passive second coil carcass;
positioning an active first coil carcass in the centre of the gap of the motor;
soldering wire outlets of the passive second coil carcass onto the active first coil carcass;
gluing an internal membrane onto the external membrane;
gluing the internal membrane onto the active first coil carcass.

This method makes it possible to, first of all, manufacture coil carcasses (active and passive) using established manufacturing methods, and then to assemble the speaker using proven conventional techniques, with two additional steps consisting of electrically connecting the two coils, then structurally connecting them through the gluing of an intermediate membrane which combines the functions of a core cover (with regard to gluing on the external membrane element) and also of a conventional membrane with regard to gluing with the active coil.

### BRIEF DESCRIPTION OF THE FIGURES

Other advantages, aims and particular features of the invention will become apparent from the non-limiting description that follows of at least one particular embodiment of the speaker that is the subject of the present invention, with reference to drawings included in an appendix, wherein:

FIG. 1 represents, schematically, an axial half-section of a speaker of the prior art;

FIG. 2 represents, schematically, an axial half-section of a speaker according to an aspect of the present invention;

FIG. 3 represents an axial section to scale of a particular embodiment of the speaker according to at least one aspect of the present invention;

FIG. 4 represents an enlarged detail of FIG. 3;

FIG. 5 represents a front suspension of a variant of the speaker that is the subject of the invention;

FIG. 6 represents, in an exploded view, the speaker shown in FIG. 3;

FIG. 7 represents, in the form of a logic diagram, steps in a particular embodiment of the method for assembling a speaker, which method is the subject of the invention; and

FIG. 8 is a representation in axisymmetric cross-section of the motor and winding with the magnetic field lines.

### DESCRIPTION OF EMBODIMENTS

The present description is given in a non-limiting way, in which each characteristic of an embodiment can be combined with any other characteristic of any other embodiment in an advantageous way.

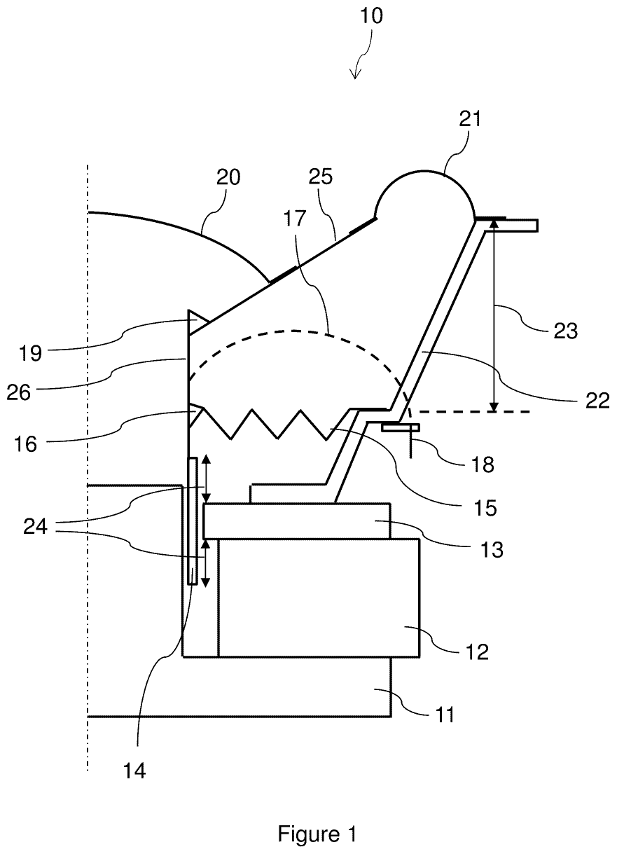

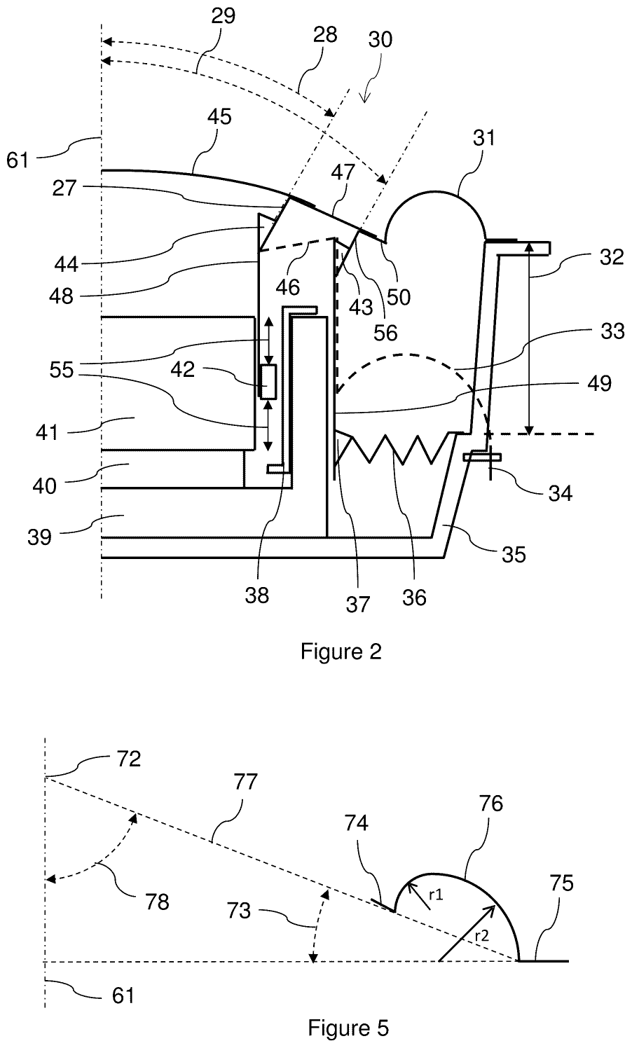

It is now noted that FIGS. 1 and 2 are not to scale.

The field of the invention is the speaker or electrodynamic transducer, and more specifically a speaker dedicated in particular to the reproduction of low frequencies (“large” effective projected area, “heavy” moving part, high excursion, high force factor, high power handling).

One of the objectives of the invention is to reduce the dimensions, in particular the depth, of a speaker designed in particular to reproduce low frequencies, while preserving the special properties necessary for the high-quality reproduction of low and medium frequencies in the audible spectrum.

Compactness becomes necessary when one seeks to reduce the size, in particular the depth, of the cabinets/acoustic baffles coupled to this speaker and necessary for it to operate properly.

Throughout the description, the term “front” refers to a location on the membrane side of the speaker, and “rear” to a location on the opposite side. In addition, the term “internal” refers to a location near to the axis of symmetry of the speaker, and “external” to a location farther away from this axis of symmetry. FIG. 1 shows a speaker 10 of the prior art, which comprises:
a yoke 11;
a magnet 12, generally made of ferrite;
a field plate 13;
a winding 14, generally with two layers, on a coil carcass 26;
a rear suspension 15 connected by a rear gluing 16 to the coil carcass 26;
a connector 18 of an electrical power supply 17 for the winding 14;
a gluing 19 connecting a membrane 25 to the coil carcass 26;
a core cover 20;
a front suspension 21; and
a basket 22.

It shows, in particular, the distance Δsusp 23 between the front 21 and rear 15 suspensions necessary to ensure the good translational guide of the moving coil carcass 26 (Speaker with high excursion±Xmax 24). This distance 23 does not permit the height of a conventional design speaker to be reduced.

FIG. 2 shows a speaker 30 that is the subject of the invention, which comprises:
a front suspension 31;
a connector 34 of an electrical power supply, formed by electrical wires 33 and 46 of a winding 42 mounted on a first, internal, coil carcass 48;
a basket 35;
a rear suspension 36, connected by a gluing 37 to a second, external, coil carcass 49;
a gluing 43 connecting the external second coil carcass 49 to an external membrane 50;
a core cover 45 and an internal membrane 47 connected by a gluing 44 to the internal first coil carcass 48;
a ring 38;
a yoke 39, for example made of soft steel;
a magnet 40;
a field plate 41, for example made of soft steel.

The excursion is represented by arrows 55.

The assembly formed by the core cover 45, the internal membrane 47 and the external membrane 50 has a convex shape, the convexity of which is oriented towards the outside of the speaker 30.

The magnet 40 is preferably made of Neodymium-Iron-Boron (NdFeB). The winding 42 is preferably a winding with four to eight layers, for example six.

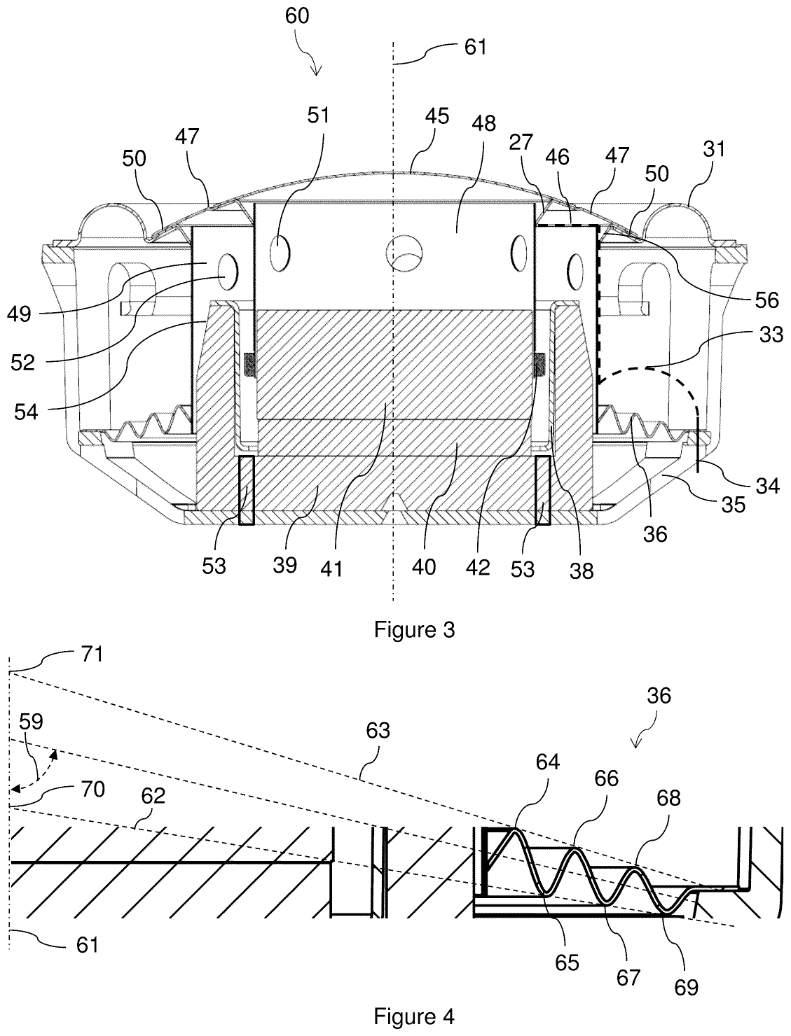

FIG. 3 shows the elements illustrated in FIG. 2, except for the gluing spots. FIG. 3 also shows ventilation holes 51 in the internal first coil carcass 48 and ventilation holes 52 in the external second coil carcass 49. The yoke 39 also has through-openings 53 for decompression/ventilation.

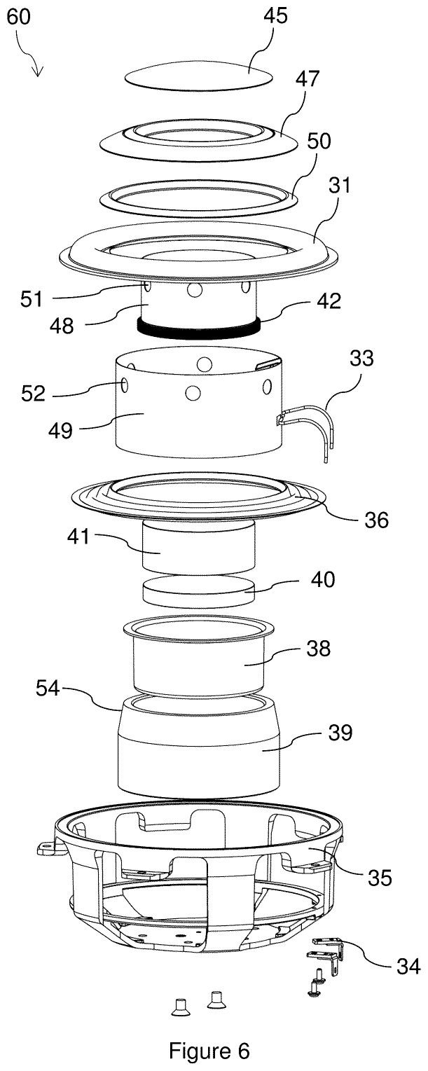

FIG. 6 shows the elements illustrated in FIG. 3. FIGS. 3 to 5 are each to scale, but the scales are different.

With regard to the materials, the front suspension 31 is, for example, made of elastomer. The basket 35 is, for example, made of aluminium. The external second coil carcass 49 is referred to as “passive” since it does not interact with the magnetic field. This external carcass 49 is, for example, a carcass of polyimide (imide-based polymer) reinforced with aramid or meta-aramid. The rear suspension 36 is, for example, made of coated fabric. The active internal first coil carcass 48 is, for example, made of aluminium reinforced with aramid or meta-aramid. The ring 38 is, for example, made of copper or aluminium (materials with magnetic permeability approximately equal to 1, these materials cannot therefore channel the magnetic field). The core cover 45 is, for example, made of carbon and epoxy (polyepoxides, also known as polymer epoxides).

A particular feature of at least one aspect of the invention consists of adding the external second coil carcass 49 to the moving part to position the rear suspension (“spider”) 36 outside and towards the back of the speaker 30. This second coil carcass 49 makes it possible to maximise the distance 32 between the front 31 and rear 36 suspensions, ensuring the good translational guide of the moving part while reducing the depth of the speaker 30.

The second carcass 49 is external relative to the first carcass 48, i.e. farther from the axis of symmetry of the speaker 30.

Note that there is no winding on this external second coil carcass 49. The speaker 30 is not a coaxial speaker. The second coil carcass 49 is referred to as a coil “carcass” because it is manufactured in a similar way to a conventional coil carcass, except that it has no coil or winding. Nevertheless, the external second coil carcass 49 is traversed by the electrical signal of power supply for the winding 42 by the two conductors 33. These conductors 33 are continued, from the front of the external coil carcass 49, as conductors 46 along an aerial path to reach the front of the active internal first coil carcass 48. The main function of the second coil carcass 49 is therefore a rigid structural extension. The assembly formed of the active coil carcass 48, the internal membrane 47, the external membrane 50, the core cover 45 and the passive coil carcass 49 moves as a single piece. This assembly, or moving part, forms a rigid structure.

The front 31 and rear 36 suspensions are flexible. They deform easily to ensure the translational movement of this “rigid” assembly comprising the elements 45, 47, 48, 49 and 50.

The front 31 and rear 36 suspensions hold the movements of the external carcass 49, and therefore of this assembly, along the axis of the speaker 30.

The membrane elements, internal 47, external 50 and core cover 45, and also the coil carcasses 48 and 49 are made of “rigid” materials, for example a carbon composite or glass fabric and epoxy material for the elements of membranes 45, 47 and 50, and Kapton (registered trademark) film with Nomex (registered trademark) reinforcement for coil carcasses 48 and 49. These elements therefore move as a single entity, at least at low frequencies. This is piston mode. At high frequencies, for example above 1000 Hz, the materials begin to deform according to their modes of vibration. However, these frequencies are outside the bandwidth of the speaker 30 which is, for example, dedicated to frequencies below about 250 Hz.

All the assemblies are assemblies preferably glued, even if the glue is not systematically shown on FIGS. 2 and 3.

The rigidity of the moving assembly is the result of a combination of the shape, thickness and materials used. FIG. 3 is a figure to scale.

With regard to the moving part, the shape and the materials used at the level of the constituent parts of a speaker have a major impact on its frequency response.

Preferably, the angle 28 of the central portion 27 of the rigid membrane 47 forming a junction with the first coil carcass 48 is between 0° and 45°, preferably between 5° and 35°, relative to the axis 61.

Similarly, preferably, the angle 29 of the portion 56 of the external membrane 50 forming a junction with the second coil carcass 49 is between 0° and 45°, preferably between 5° and 35°, relative to the axis 61.

In FIGS. 2 and 3, the angles 28 and 29 are substantially equal. In other embodiments, the angles 28 and 29 are not equal.

These portions 27 and 56 of membranes 47 and 50 are therefore cylindrical (angle 28 or 29 or 0°) or, preferably, conical, which is favourable to the correct rise in frequency of the speaker and to its resistance to high mechanical loads/stresses. In addition, the shape, and therefore the production, of these portions 27 and 56 of membranes 47 and 50 is simple because this production does not require a costly resin injection tool. The membranes 47 and 50 can be very light, which is favourable to the acoustic quality of the speaker.

The angle, 28 or 29, equal to 0° makes it possible to deposit the glue which becomes the gluing 44 and 43, respectively.

According its first aspect, the invention provides for the utilisation of a coil carcass, preferably formed of a very thin (therefore lighter) plastic film wound on a simple mandrel, a much less costly production tool than a plastic part injection tool. Also, the force is transmitted by the coil to the rigid membrane 47 through a portion of cone 27 with angle 28 of about 30° relative to the axis 61 and a gluing 44 or 43. This angle 28 and this gluing 44 or 43 allow a better transmission of the coil force of the first carcass 48, thereby ensuring a better rise in frequency and better power handling, especially in terms of risks of mechanical breakage.

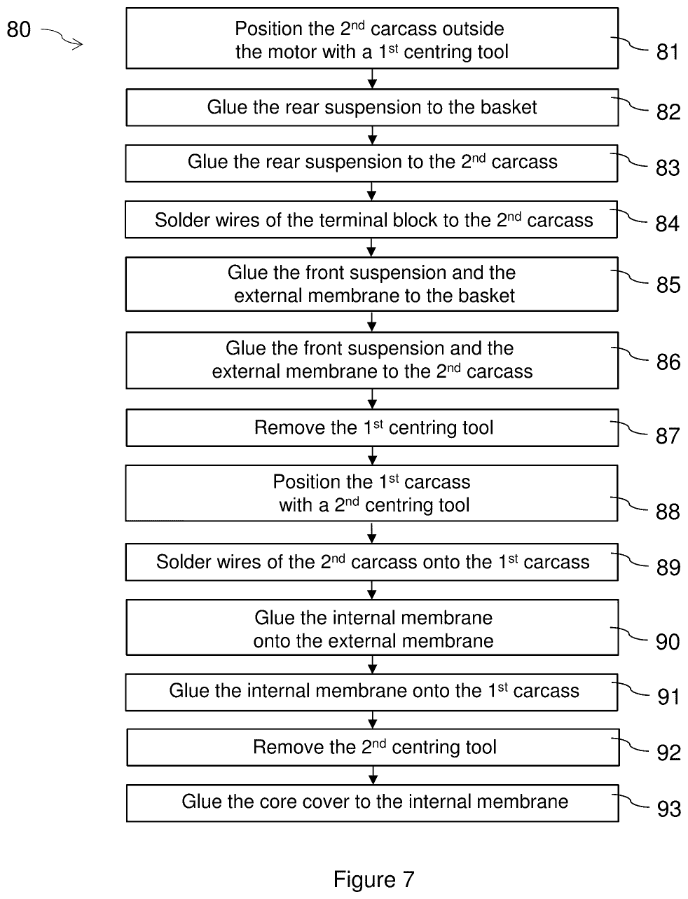

The special shape of the membrane elements associated with the method of assembling the various elements (see FIG. 7) makes it possible to move the external membrane 50 above the upper end of the second carcass 49 in order to pass, during assembly, the connecting wires 46 under the external membrane 50.

The shape of the speaker that is the subject of the invention is preferably convex, increasing the compactness of the speaker. In effect, this convex shape maximises the inner volume of the speaker and the cabinet that contains it and reduces the total height (measured parallel to the axis 61) of the basket 35. In addition, a concave shape would reduce the internal volume of air of the enclosed load whereas the convex shape increases it.

The convex shape of the membrane elements of the speaker also increases the flexural rigidity of this membrane. By comparison, a flat membrane has a much lower modulus of flexural rigidity, which can lead to a reduction in the top end of the bandwidth of the speaker.

The flexural rigidity of the membrane is even more necessary when it is used with an enclosed load with a small volume, as is the case with the speaker described in the figures. In effect, the membrane must withstand the return force created by the modification of the internal pressure of the speaker, to prevent the membrane from being abruptly “shaken” by buckling of the structure, like a suction.

The solution presented above is boosted by a certain compactness of the motor (magnetic circuit), especially with regard to the external diameter. Given the significant constraints linked to the design of the motor of good low speakers, its design is therefore especially optimised in terms of compactness/performance by:
the central magnet 40 of Neodymium-Iron-Boron type;
the “underhung” design;
the large-diameter coil carcass 48;
the winding 42 with six layers; and
the counter-inductance ring 38.

The architecture of the motor is referred to as “underhung”. Unlike overhung motors—in which the coil is higher than the gap, where the Xmax (maximum excursion) is defined such that, when the coil moves, there is always a same-sized portion of the coil opposite the gap—on an underhung motor, the gap is higher than the coil. The Xmax will therefore be defined such that when the coil moves it is always in the gap.

In the case of the underhung motor, if one remains within the Xmax limits, all of the coil is always completely opposite the gap and the force exerted varies less after excursion.

Another particular feature of at least one aspect of the invention is the asymmetric shape of at least one suspension, i.e. where the central portion is oriented towards the front of the speaker. This design makes it possible to compensate for the non-linearity of the acoustic stiffness of the closed cabinet coupled to the speaker, a significant non-linearity, in the case of a low load volume (a case frequently inherent in the use of a speaker with a small depth).

A particular embodiment of the speaker that is the subject of the present invention is described below. This particular embodiment concerns a speaker with a size of between four and nine inches, for example 6.5 inches (about 17 cm external diameter).

In this particular embodiment, the motor (magnetic circuit) is of a standard underhung design with an NdFeB (Neodymium-Iron-Boron) type of central magnet.

The winding has between four and eight, for example six, layers for maximising the force factor Bl, product of the magnetic field B in the gap (from the magnetic circuit) and the length l of the electric conductor immersed in the gap.

A ring 38 made of copper or aluminium with a thickness of between 0.5 and two millimetres, for example one millimetre, for example produced by stamping, in inserted inside the gap and covers the entire height of the gap to reduce the inductance of the winding 42 to improve the efficiency of the speaker 30 at the top end of its bandwidth and to reduce distortions, especially current distortions.

The position of this ring 38 on the outer side of the gap allows the diameter of the magnet 40 to be maximised for a given diameter of the inner coil carcass 48, which maximises the magnetic energy, while keeping a precisely toleranced reference diameter (the external diameter of the field plate 41) for carrying out the precise assembly of the moving coil carcass 48 using a centring tool.

Preferably holes 53 are made in the yoke 39 at the location of the diameter of the gap to facilitate the circulation of air in the latter for the purpose of cooling the winding of the internal coil carcass 48 by forced cool air ventilation.

For example, the coil form, or coil carcass, 48 is made partly of aluminium so that the copper winding better dissipates the heat generated by the Joule effect.

Made in this way, this motor has outstanding performance levels in terms of the ratio compactness/magnetic energy, in terms of linearity (thanks to the underhung motor associated with the copper or aluminium ring 38) and in terms of power handling (thanks to the underhung motor associated with forced ventilation holes 43, coil form made of aluminium).

With regard to the complete design of the magnetic circuit, it is of the “underhung” type with central magnet, having multi-layer winding (preferably at least four layers) and a counter-inductance ring positioned outside and over the entire height of the gap.

The following are examples of preferred dimensions:
coil diameter between 40 and 100 mm;
gap width depends on the thickness of the winding, dependent on the cross-section of the wire used, number of coils, for example between 2 and 6 mm;
winding height, between 5 and 15 mm;
gap height between 15 and 50 mm; and
magnet height between 3 and 12 mm.

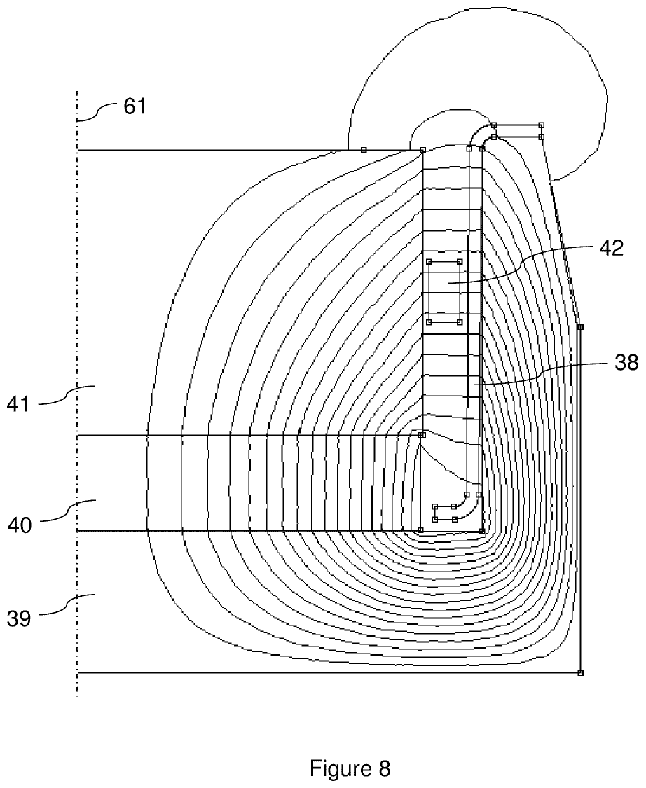

As shown in FIG. 8, the ring 38 does not alter the magnetic field lines since the material it is made from is non-magnetic.

On the other hand, the ring 38 creates an inductive coupling with the active winding 42, a coupling that enables this active winding 42 to reduce its self-inductance. The speaker is therefore more efficient in the top of its bandwidth. In addition, this reduces distortions linked to the variation in inductance of the active winding 42.

The combination of:
a motor with a central magnet;
an “underhung” design;
a counter-inductance ring positioned outside and over the entire height of the gap; and
a winding, preferably with at least four layers,
   thus gives the speaker of the invention excellent performance levels and good compactness.

Preferably, the counter-inductance ring 38 is produced by stamping a plate or sheet of aluminium or copper, an inexpensive and less complex production method than producing a thin copper or aluminium cylinder with a large diameter by conventional machining. Alternatively, a metal three-dimensional printing method can be utilised to produce the counter-inductance ring 38.

The design with a central magnet makes it possible to prevent magnetic links. The underhung design ensures that the magnetic field is constant as a function of the displacement of the winding 42, which results in better linearity of operation and minimisation of distortion.

Using a winding with at least four winding layers makes it possible to compensate for the magnetic field loss resulting from the use of the underhung motor. In effect, what one seeks to maximise is the force factor B*I, product of the magnetic field B and the length l of the electric conductor in the gap. Placing four layers, compared to the conventional case of two layers, enables the force factor Bl to be doubled (for the underhung design). Similarly, six layers enables this force factor Bl to be tripled. However, the person skilled in the art knows that a large number of layers increases the thickness of the winding, and therefore of the gap. By increasing the width of the gap, the B is decreased. Moreover, the use of a coil with four or six layers results in excess weight and increases its self-inductance. The use of a counter-inductance ring 38 of one of the aspects of the invention ensures, by inductive coupling, the reduction of the self-inductance of the moving active winding 42. In addition, by placing this ring 38 over the entire height of the gap its action is independent of the position of the moving part during its displacement. In addition, positioning the counter-inductance ring 38 outside the winding 42 makes it possible to maximise the diameter of the magnet and keep an inner diameter of the gap to the very precise dimensions necessary as reference for centring the moving first coil carcass during assembly (see FIG. 7).

The representation in axisymmetric cross-section of the motor and winding in FIG. 8 shows the magnetic field lines, and in particular that there is very little magnetic leakage, i.e. a field line that loops in the external air outside the magnetic circuit.

The entire electro-magnetic circuit, including the ring and the active winding, is especially well optimised in terms of performance and compactness.

The active first coil carcass 48 (with the winding immersed in the magnetic gap) is secured to the passive second coil carcass 49 (which connects the front 31 and 36 suspensions) via two rigid membrane portions 47 and 50 (carbon/epoxy composite). Electric current flows through the conductors 33 of the passive second coil carcass 49, particularly, even primarily, for the purpose of being transmitted to the active coil carcass 48. Conductive wire 46 that is fairly rigid, for example similar to that used for the winding of the active coil carcass 48, is used to transmit the current to the active coil carcass 48.

Two conductive wires 46 are fixed vertically to the passive second coil carcass 49 and pass above of it to carry the electrical signal to the active first coil carcass 48. The electrical connection between the two coil carcasses 48 and 49 is made, for example, by soldering, for example soft soldering, the top ends of the wires of the passive coil carcass 49 on two solder areas positioned on the top of the active coil carcass 48, these two solder areas being connected to the two ends of the winding 42 immersed in the magnetic gap. Two flexible conductive wires 33 mechanically resistant to vibrations are then used to connect, via an aerial path, the passive coil carcass 49, mobile, to the terminals 34, fixed, of the speaker 30.

The top of the active 48 and passive 49 coil carcasses is preferably pierced with many holes, respectively 51 and 52, to decompress the volume of air trapped between the motor, the membranes and these coil carcasses 48 and 49. A large number of holes 51 and 52 is preferable in order to reduce the air turbulence phenomena that can appear and cause parasitic noise during great speeds and amplitudes of vibration of the moving part. A chamfer 54 realised on the upper outer portion of the yoke 39 is also provided for this purpose, to facilitate the passage of air via the holes 52 of the passive coil carcass 49, when the moving part is in a low position.

One excellent quality of this design is that it enables assembly using the conventional methods for assembling speakers with just a few additional steps.

The manufacture of a conventional speaker has the following steps:
a) Position the active first coil carcass in the centre of the gap using a dedicated centring tool;
b) Glue the rear suspension to the basket;
c) Glue the rear suspension to the coil carcass;
d) Glue the assembly (front suspension and membrane) to the basket;
e) Glue the assembly (front suspension and membrane) to the coil carcass;
f) Remove the centring tool from the coil carcass;
g) Glue the core cover to the membrane.

The manufacture or assembly of a speaker with two carcasses has the following steps:
a) Position the passive second coil carcass 49 outside the motor using a dedicated first centring tool, step 81, FIG. 7;
b) Glue the rear suspension 36 to the basket 35, step 82; it is noted that steps 81 and 82 can be exchanged;
c) Glue the rear suspension 36 to the passive second coil carcass 49, step 83; it is noted that steps 82 and 83 can be exchanged;
d) Solder wires of the second carcass to the terminal block, step 84;
e) Glue the assembly (front suspension 31 and external membrane 50) to the basket 35, step 85;
f) Glue the assembly (front suspension 31 and external membrane 50) to the passive second coil carcass 49, step 86;
g) Remove the first centring tool from the passive second coil carcass 49, step 87;
h) Position the active first coil carcass 48 in the centre of the gap using a dedicated second centring tool, step 88;
i) Solder the wire outlets of the passive second coil carcass 49 onto the active first coil carcass 48, step 89;
j) Glue the internal membrane 47 onto the external membrane 50, step 90;
k) Glue the internal membrane 47 onto the active first coil carcass 48, step 91;
l) Remove the centring tool from the active first coil carcass 48, step 92; and
m) Glue the core cover 45 to the internal membrane 47, step 93.

More generally, the method for assembling a speaker that is the subject of the invention comprising, in order, the following steps:
position 81 a passive second coil carcass 49 outside a motor 38, 39, 40 and 41;
solder 84 wires of the second carcass to the terminal block;
glue 86 a front suspension 31 and an external membrane 50 to the passive second coil carcass;
position 88 an active first coil carcass 48 in the centre of the gap of the motor;
solder 89 wire outlets 46 of the passive second coil carcass onto the active first coil carcass;
glue 90 an internal membrane 47 onto the external membrane;
glue 91 the internal membrane onto the active first coil carcass.

The path of the wires from the terminal block (fixed) to the active coil (mobile) allows coils (active and passive) to be manufactured using established manufacturing methods. Then, the method comprises assembling the speaker using proven conventional techniques, requiring two additional steps consisting of electrically connecting the two coils, then structurally connecting them through the gluing of an intermediate membrane which combines the functions of a core cover (with regard to gluing on the external membrane element) and also of a conventional membrane with regard to gluing with the active coil.

In this way, the speaker is assembled like a Russian doll but from the outside to the inside. The production cost of the speaker is therefore reduced.

In some embodiments, at least one suspension has a rotationally symmetrical shape whose radial cross-section exhibits oscillations whose extreme amplitudes form at least one cone whose apex is oriented towards the front of the speaker.

In the embodiment shown in FIG. 5, the front suspension 76 has an area 75 for gluing on the basket and an area 74 for gluing on the membrane. This suspension 76 has a rotational symmetry about the axis 61. The radial cross-section shown in FIG. 5 exhibits oscillations whose extreme amplitudes, here the extremes being oriented towards the rear of the speaker, form a cone 77 whose apex 72 is oriented towards the front of the speaker.

In other words, the angle 78 less than 90° at the point where the cone 77 and the axis 61 meet is oriented towards the rear of the speaker.

In FIG. 5, the front suspension 76 is formed of two open quarter-tori with the same large diameter and different small diameters of which the radial cross-section shown in FIG. 5 comprises two quarter circles tangential to each other with an internal radius r1 and external radius r2, where r1<r2.

According to some variants, for at least one suspension:
the amplitude of the oscillations is greater towards the central axis of the rear suspension than towards the perimeter of the rear suspension;
the amplitude of the oscillations is lower towards the central axis of the rear suspension than towards the perimeter of the rear suspension.

In some embodiments, as shown in FIGS. 3 and 4, the rear suspension 36 is asymmetric in its function of translational guidance of the moving part, as shown in FIGS. 3 and 4.

Thanks to this design, the mechanical stiffness of the front 76 and/or rear 36 suspension, which stiffness is a function of the axial translational displacement of the moving part, is non-linear. This stiffness is, in absolute value, greater for a movement towards the front of the moving part, which requires an elongation of the conical shape and therefore a return force whose axial component is increased, and less for a movement towards the rear, in which the conical shape is flattened so that the axial component is reduced.

The suspensions are jointly configured to apply to the moving part a return force that compensates for the non-linearity due to the variation in acoustic stiffness produced by the compression/depression of the internal load volume.

This non-conventional design of at least one suspension compensates, at least partially, for the acoustic non-linearity of the volume of air of the closed cabinet associated with the speaker 60. In effect, this asymmetry of at least one suspension, relative to any plane perpendicular to the axis of displacement of the moving part, has in particular a benefit for use in a compact cabinet, in which there is not much space to position a speaker, and therefore a cabinet with a small internal volume.

Typically, in this compact speaker, the volume of air displaced by the membrane, product of the surface and the maximum displacement, i.e. two times the excursion, is non-negligible with respect to the small volume of the enclosed load. The volume of the enclosed load therefore fluctuates with the displacement of the membrane in a significant way. The order of magnitude of the ratio of the volume of air displaced by the movement of the moving part to the initial volume of the enclosure is greater than two percent, preferably three percent of the volume of air and, even more preferably, four percent. But these few percentages have a very adverse effect on the non-linearity of the acoustic stiffness/load.

This small volume results in an acoustic stiffness of the closed cabinet that is significant and substantially non-linear with regard to the displacement of the membrane of the speaker. With an enclosed load of small volume, a significant displacement of the membrane causes a significant change in the internal volume V of the enclosed load and, consequently, in the internal static pressure P, these two values being connected by Laplace's Law:

$${[ PV ]}^{∧} γ = C\_ 1 \qquad ( 1 )$$

where C_1 is a constant, and γ=1.4 in the case of air.

The following is deduced:

$$P ( x ) = {{P}_{0} ( {V}_{0} / ( {V}_{0} + Sx ) )}^{∧} 1.4 \qquad ( 2 )$$

### Where:

x is the displacement of the membrane (positive and negative, x=0 being the rest position)
P₀ is the static pressure at equilibrium (x=0)
V₀ is the internal volume of the cabinet (x=0)
S is the radiating surface of the membrane
“\hat{ }” represents a power, here power 1.4.

In the case of a compact cabinet, in which Sx is not negligible with respect to V₀, the change of internal pressure results in a force on the membrane of the speaker with a non-linear behaviour. The return pressure exerted on the membrane is notably greater for a displacement of the membrane to the inside of the cabinet (the rear) than to the outside (the front). Therefore, a larger force is necessary to move the membrane to the inside than to the outside. The asymmetric suspensions, i.e. where the central portion is oriented to the front of the speaker, are designed in the inverse: they exert a greater return force for an outward displacement (to the front of the speaker) than inwards in order to compensate for the non-linearity linked to the change of internal volume of the chamber with the displacement of the membrane.

In the embodiment shown in FIGS. 3 and 4, the rear suspension 36 has a shape with rotational symmetry about the axis 61. The radial cross-section shown in FIG. 4 exhibits oscillations between local maximums 64, 66 and 68 and local minimums 65, 67 and 69, which are continued, on the outside to the basket 35, and, on the inside to the second coil carcass 49. The local maximums 64, 66 and 68 are colinear, and the local minimums 65, 67 and 69 are colinear. Consequently, the oscillations represented by the axial cross-section form two cones, rear 62 and front 63, whose apexes 70 and 71 are oriented towards the front of the speaker, relative to the rear suspension 36. Preferably, the angle at the apex of the front cone 63 is smaller than the angle at the apex of the rear cone 62. In other words, the amplitude of the oscillations is greater towards the central axis 61 of the rear suspension 36 than towards the perimeter of the rear suspension 36. The oscillations have a constant pitch, i.e. the distance between the apexes 64 and 66 is equal to the distance between the apexes 66 and 68 and the distance between the apexes 65 and 67 is equal to the distance between the apexes 67 and 69. FIG. 4 shows that the oscillations are sinusoidal.

In some variants, at least one suspension has another oscillation shape (semi-sinusoidal, triangles, circular arcs, etc.) with amplitudes and pitches constant or not. The basis of the stiffness dissymmetry is the angle of inclination 73 between the internal and external extremities of the suspension, in which the excursion of the moving part is zero.

With regard to the asymmetric suspensions, the specification has been described above on which the sizing of the stiffness asymmetry of the suspensions (front, rear, or a mixture of both) is based in order to compensate for the non-linearity due to the variation in acoustic stiffness produced by the compression/depression of the internal load volume, see the formula (2) above.

The variation in pressure ΔP(x)=P(x)−P₀ generates a return force F(x)=−ΔP(x)*S on the radiating surface of the speaker and therefore an acoustic stiffness Kₐ(x)=F(x)/x.

According to one aspect of the invention, suspensions are utilised whose combination has a mechanical stiffness Kₘ(x) with the opposite profile of stiffness Kₐ(x) such that the addition of mechanical and acoustic stiffness is substantially constant according to the displacement x, i.e. Kₐ(x)+Kₘ(x)=Kₜ or Kₜ is a constant, the total stiffness of the system, no longer dependent on x.

Note that the acoustic stiffness is, in the case of a closed compact system, greater than the mechanical stiffness linked to the suspensions of the speaker when these suspensions are perpendicular to the axis of the speaker. By providing for a change in the mechanical stiffness as a function of the displacement x with an opposite profile to the profile of the acoustic stiffness, one recreates a total stiffness invariant with respect to the displacement x.

In a first approach, the force exerted by the spring is considered, this spring being formed of the rear suspension 36 and the front suspension 76, oriented according to an angle, respectively 59 (see FIG. 4) and 78 (see FIG. 5). For the rear suspension, a length l of the spring is obtained that is equal to

l=(x+constant) sin 59.

Therefore, in this linear model, the displacement x of the winding 42 results in an elongation or a compression of this spring and thus a return force that is a function of x. The same is true for the front suspension 76.

In a second approach, finite element software is used to calculate structures using non-linear behaviour models of materials, (large displacement, large rotation, hyper-elasticity, etc.).

In this way, suspensions are obtained with an amplitude range, for example up to ±18 mm of the value of x, which is significant in the context of the speaker described here. The phase of non-linear calculation of stiffnesses is followed by a phase of validation tests on prototype for the final adjustment of the shape and materials of suspension used.

In FIG. 1, the distance 23 between the front and rear suspensions necessary to ensure the good translational guide of the moving coil carcass (speaker with high excursion±Xmax 24 and 55) prevents the height of a conventional design speaker to be reduced. One of the aspects of the invention makes it possible to reduce the height of the speaker significantly with no reduction in this distance and maintaining similar performance levels in terms of force factor, mass of the moving part and inductance of the winding. In addition, the “underhung” design even makes it possible to improve the linearity of the parameters of the speaker with respect to the displacement of the winding 42.

On the “state of the art” conventional speaker of FIG. 1, the design of the magnetic gap and the winding is of the “overhung” type: the winding is higher than the magnetic gap area, to ensure that the force factor Bl (product of the magnetic field B and the length of the electric conductor immersed in the magnetic field) does not change too much with respect to the displacement of the coil carcass. The magnet is of the ferrite type. To ensure a strong magnetic field, the ferrite is necessarily of a large size (large diameter, large height) and placed outside the winding. The winding is generally formed of two winding layers.

In the particular embodiment of one aspect of the invention shown in FIG. 2, the design of the magnetic gap and winding 42 is of the “underhung” type. The winding 42 is shorter than the magnetic gap area. The constancy of the force factor Bl as a function of the displacement of the winding 42 is improved. Similarly, the constancy of the inductance of the winding 42 as a function of the displacement of the first coil carcass 48 is improved. The power handling of the winding is also improved, by improving the heat dissipation. The winding 42 that heats via the Joule effect is, over its entire height, close to thermally conductive parts that help to dissipate the heat of the winding 42.

The magnet 40 is preferably of the NdFeB type. Much more powerful than ferrite, this type of magnet makes it possible to dramatically reduce the size of magnets in the design of magnetic circuits. This type of magnet enables the design of the compact, powerful motor proposed, and in particular to position the magnet at the centre of the motor, by increasing the diameter of the winding 42. Positioning the magnet 40 in the centre offers another considerable advantage compared to a configuration with an exterior magnet: the assembly has almost no magnetic leakage. Practically all the magnetic field lines are channelled by the polar parts 39 and 41, made of soft steel, which surround the magnet 40. In contrast, in a design with an external magnet, magnetic field lines loop in the air outside the magnet resulting in magnetic leaks (the magnet in an external position easily attracts iron-based materials and can cause electromagnetic disturbances in its immediate surroundings).

This design increases the inductance of the winding 42 compared to the standard design, because of the use of a large-diameter first coil carcass 48 with a greater number of winding turns and a larger steel core. To remedy this, according to one aspect of the invention, a copper or aluminium ring 38 is used, placed in the magnetic gap, close to and outside the winding 42.

The combination of different aspects of the invention has the following advantages:
a) Compactness of the speaker, in particular reduced depth;
b) Simplicity of assembly (use of conventional assembly methods);
c) High force factor (central Neodymium magnet, large-diameter six-layer winding);
d) Low to moderate inductance (given the use of a large-diameter coil carcass with four to eight layers) thanks to the copper or aluminium counter-inductance ring, which allows the speaker to be more efficient in the top of its bandwidth.
e) Linearity: Thanks to the underhung assembly, the force factor is not dependent on the position of the winding; the copper or aluminium ring makes it possible to reduce the non-linearity phenomena linked to variations in the inductance of the moving coil and the linearity of the overall mechanical stiffness of the system (speaker and closed cabinet) is controlled by means of the asymmetric spider.
f) High power handling by means of the active coil carcass made of aluminium, the ventilation holes 53 in the bottom of the yoke 39, and the “underhung” type of motor.

In this way, the design of the entire moving part associated with the method of assembling the speaker (including the path of the power supply wires of the coil) makes this speaker design especially optimised in terms of performance and compactness, and also enables easy assembly.

1. A speaker, which comprises a magnet associated with at least one polar part for producing a magnetic field in a gap and a moving part comprising:
a first coil carcass supporting a conductive winding in the gap;
a rigid internal membrane and a core cover secured to the first carcass;
also comprises:
a second coil carcass positioned on the outside of the polar parts and mounted on a rear suspension;
an external membrane secured to the rigid internal membrane, the second carcass and a front suspension; and
two electric conductors connected to the winding and passing through the first coil carcass, an aerial path between the coil carcasses, the second coil carcass and an aerial path to a fixed point of the speaker, the assembly formed by the core cover, the internal membrane and the external membrane having a convex shape, the convexity of which is oriented towards the outside of the speaker, the rigid internal membrane comprising a cylindrical or conical portion inside the speaker and secured to the first coil carcass, the external membrane comprising a cylindrical or conical part inside the speaker and secured to the second coil carcass.

2. The speaker according to claim 1, wherein, in orthogonal projection along the axis of displacement of the moving part, the gap has a length greater than the length of the winding, the front and rear suspensions being configured to maintain the entire winding in the gap up to the maximum excursions of the moving part.

3. The speaker according to claim 1, wherein the magnet is a central magnet whose orthogonal projection orthogonal along a plane perpendicular to the axis of displacement of the moving part is completely inside said projection of the first coil carcass, two polar parts being mounted on two surfaces of the magnet.

4. The speaker according to claim 1, wherein the diameter of the first coil carcass is more than half the outer diameter of the external membrane.

5. The speaker according to claim 1, wherein the winding comprises at least four layers.

6. The speaker according to claim 1, wherein at least one of the coil carcasses comprises air circulation through-openings.

7. The speaker according to claim 1, wherein the external polar part has a chamfer on the side of the second coil carcass.

8. The speaker according to claim 1, wherein the external polar part comprises through-openings parallel to the axis of displacement of the moving part.

9. The speaker according to claim 1, which comprises, in the gap, a counter-inductance ring.

10. The speaker according to claim 9, wherein the counter-inductance ring is positioned in the gap outside the winding, the magnet being a central magnet whose orthogonal projection along a plane perpendicular to the axis of displacement of the moving part is completely inside said projection of the first coil carcass, the two polar parts being mounted on two surfaces of the magnet.

11. The speaker according to claim 9, wherein the counter-inductance ring is made of materials with a magnetic permeability approximately equal to 1.

12. The speaker according to claim 9, wherein the counter-inductance ring is made of copper or aluminium.

13. The speaker according to ene of claim 9, wherein the counter-inductance ring covers the entire height of the gap.

14. The speaker according to claim 9, wherein the counter-inductance ring has a thickness of between 0.5 and two millimetres.

15. The speaker according to claim 14, wherein the magnet is made of Neodymium-Iron-Boron (NdFeB).

16. The speaker according to claim 1, the suspensions being jointly configured to apply to the moving part a return force that compensates for the non-linearity due to the variation in acoustic stiffness produced by the compression/depression of the internal load volume.

17. The speaker according to claim 16, wherein the amplitude of the oscillations is greater towards the central axis of the rear suspension than towards the perimeter of the rear suspension.

18. The speaker according to claim 16 wherein the oscillations have a constant pitch.

19. The speaker according to claim 16, wherein the oscillations are sinusoidal.

20. Method for assembling a speaker with two carcasses, characterised in that it comprises, in order, the following steps:
position a passive second coil carcass outside a motor;
solder wires of the second carcass to a terminal block of the speaker;
glue a front suspension and an external membrane to the passive second coil carcass;
position an active first coil carcass in the centre of the gap of the motor;
solder wire outlets of the passive second coil carcass onto the active first coil carcass;
glue an internal membrane onto the external membrane;
glue the internal membrane onto the active first coil carcass.
